(19) United States
(12) Patent Application Publication
(10) Pub. No.: US 2026/0038351 A1
(43) Pub. Date: Feb. 5, 2026

(54) Security And Deterrent Systems And Methods For Emergency Detection, Response, And Intervention

(71) Applicant: Casey Little, Atlanta, GA (US)

(72) Inventor: Casey Little, Atlanta, GA (US)

(21) Appl. No.: 19/275,480

(22) Filed: Jul. 21, 2025

Related U.S. Application Data
(60) Provisional application No. 63/679,540, filed on Aug. 5, 2024.

(51) Int. Cl. G08B 15/02; G08B 13/189

(52) U.S. Cl. CPC G08B 15/02; G08B 13/189

(57) ABSTRACT

A security or deterrent system including a processing platform comprising one or more processors, a network of sensors including at least one of the group of motion sensors, cameras, infrared sensors, noise detectors, or radio frequency (RF) receivers, and a countermeasure subsystem including at least one of the group of a sound-making device, a visual obscurant device, and a fire mitigation device, wherein the processing platform is in communication with the network of sensors and countermeasure subsystem.

### CROSS-REFERENCE TO RELATED APPLICATIONS

This application claims the benefit of U.S. Provisional Application No. 63/679,540, filed 5 Aug. 2024, which is incorporated herein by reference in its entirety as if fully set forth below.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### SEQUENCE LISTING

Not Applicable

### STATEMENT REGARDING PRIOR DISCLOSURES BY THE INVENTOR OR A JOINT INVENTOR

Not Applicable

### BACKGROUND OF THE DISCLOSURE

### 1. Field of the Invention

The various embodiments of the present disclosure relate generally to security systems and methods, and more particularly to security and/or deterrent systems designed to detect and respond to active shooter situations in schools, warehouses, government buildings, and other large areas like parking lots.

### 2. Description of Related Art

A constant concern of property owners and managers is the security of the premises. Homeowners, business owners, and operators of public spaces alike must ensure that their properties are safe and secure for inhabitants and visitors. Likewise, homeowners and property managers strive to ensure that should an emergency arise, appropriate countermeasure procedures are in place to minimize loss of property or harm to individuals. Security systems are designed to alert the user upon detection of danger. These systems can be mobile or stationary and can detect dangers such as fire, smoke, or intrusion. Security systems can allow for the detection of danger and enable a response to reduce the threat to individuals. However, conventional security systems are challenged by providing limited options for response to perceived threats which can include fire, smoke, active shooter events, or intrusion.

What is needed, therefore, is an enhanced security system to detect and interdict several types of threats, such as active shooter threats, fire, smoke, or unauthorized entry, through a combination of sensors, countermeasures, and real-time communication. Embodiments of the present disclosure address this need as well as other needs that will become apparent upon reading the description below in conjunction with the figures.

### BRIEF SUMMARY OF THE INVENTION

The present disclosure relates generally to security systems and methods. Particularly, in any of the embodiments disclosed herein, a security system is provided designed to detect and respond to fire, smoke, intrusion, active shooter situations, or other emergency situations in schools, warehouse, government buildings, parking lots, and other areas.

In an exemplary embodiment, a security/deterrent system comprises a processing platform comprising one or more processors, a detection network comprising sensors, the detection network communicative with the processing platform, and a countermeasure subsystem comprising countermeasure devices, the countermeasure subsystem communicative with the processing platform, wherein the processing platform is configured to receive sensor data from a sensor of the detection network indicative of an emergency detected by the sensor, and deploy a countermeasure signal receivable by a countermeasure device of the countermeasure subsystem.

In any of the embodiments disclosed herein, at least a portion of the sensors of the detection network can be each selected from a group consisting of motion sensors, cameras, infrared sensors, noise detectors, radio frequency receivers, and a combination thereof.

In any of the embodiments disclosed herein, at least a portion of the countermeasure devices of the countermeasure subsystem can be each selected from a group consisting of a sound making device, a visual obscurant device, a fire mitigation device, and a combination thereof.

In any of the embodiments disclosed herein, the security/deterrent system can further comprise an emergency activation subsystem communicative with the processing platform and operable manually by a user, wherein the processing platform is further configured to receive emergency activation data from the emergency activation subsystem indicative of an emergency detected by the user, and deploy a user-initiated countermeasure signal receivable by a countermeasure device of the countermeasure subsystem.

In any of the embodiments disclosed herein, the emergency activation subsystem can comprise one or more user devices.

In any of the embodiments disclosed herein, at least a portion of the user devices of the emergency activation subsystem can be selected from a group consisting of a key fob and a mobile device.

In any of the embodiments disclosed herein, the system is configured to generate a display on the user device.

In any of the embodiments disclosed herein, the processing platform can utilize an artificial intelligence system to at least one of predict an emergency at an emergency location, detect the presence of an emergency, or send a countermeasure signal to the countermeasure subsystem.

In another exemplary embodiment, a security/deterrent system comprises a processing platform comprising one or more processors, a detection network comprising sensors, the detection network communicative with the processing platform, an emergency activation subsystem communicative with the processing platform and operable manually by a user, and a countermeasure subsystem comprising countermeasure devices, the countermeasure subsystem communicative with the processing platform, wherein the processing platform is configured to receive sensor data from a sensor of the detection network indicative of an emergency detected by the sensor at a sensor emergency location, receive emergency activation data from the emergency activation subsystem indicative of a emergency detected by the user at a user emergency location, deploy a countermeasure signal receivable by a countermeasure device of the countermeasure subsystem located in proximity of the sensor emergency location, and deploy a user-initiated countermeasure signal receivable by a countermeasure device of the countermeasure subsystem located in proximity of the user emergency location, at least a portion of the sensors of the detection network are each selected from a group consisting of motion sensors, cameras, infrared sensors, noise detectors, radio frequency receivers, and a combination thereof, and at least a portion of the countermeasure devices of the countermeasure subsystem are each selected from a group consisting of a sound making device, a visual obscurant device, a fire mitigation device, and a combination thereof, and the emergency activation subsystem comprises one or more user devices.

In any of the embodiments disclosed herein, a first fire mitigation device of the countermeasure devices can be located in proximity to at least one of a first sound making device of the countermeasure devices or a first visual obscurant device of the countermeasure devices.

In any of the embodiments disclosed herein, the fire mitigation device can be positioned below the sound making device and/or visual obscurant device.

In any of the embodiments disclosed herein, a sound making device of the countermeasure devices can be configured to produce a noise above a predetermined decibel value, and a flash of light above a predetermined candela value.

In any of the embodiments disclosed herein, a visual obscurant device of the countermeasure devices can be a spherical smoke releasing device which releases smoke within a predetermined time.

In any of the embodiments disclosed herein, the security/deterrent system can further comprise an artificial intelligence system, wherein the processing platform utilizes the artificial intelligence system to at least one of automatically adjust a sensitivity of the sensors of the detection network to detect the emergency, automatically adjust a severance of the response of the countermeasure devices, fully automate the detection of and response to the emergency, or determine a lethality of the emergency.

In another exemplary embodiment, a security system comprises a processing platform configured to receive data indicative of a presence of an emergency, wherein the one or more processors are configured with connectivity modules for wired or wireless communications, a network of sensors comprising one or more of motion sensors, cameras, infrared sensors, noise detectors, and radio frequency receivers, wherein the network of sensors is configured to detect the presence of the emergency and communicate the presence to the processing platform, an emergency activation subsystem comprising one or more of key fobs and mobile devices of a user, wherein the emergency activation subsystem is configured to send the user's detection of the emergency and communicate the presence to the processing platform, a graphical user interface displayable on the mobile device of the user, and a countermeasure subsystem comprising one or more of a sound making device configured to produce a flash of light above a predetermined candela value and a loud noise above a predetermined decibel value, a visual obscurant device comprising a spherical smoke releasing agent which releases smoke within a predetermined time, and a fire mitigation device, wherein the countermeasure device is deployable either by the user of the graphical user interface on the user device or automatically upon detection by the network of sensors of an emergency.

In another exemplary embodiment, the processing platform can further be configured to receive data from the network of sensors when the network of sensors detects the presence of the emergency, and deploy a countermeasure from the countermeasure subsystem based, at least on part on, the data received from the network of sensors.

In another exemplary embodiment, the security system can further comprise a centralized control system utilizing an artificial intelligence system to detect the presence of the emergency and deploy the countermeasure device.

In another exemplary embodiment of the present invention, a security system is provided for detecting and interdicting intruders, including without limitation active shooters, in structures including but not limited to schools, commercial buildings, government facilities, and parking lots. The system comprises a processing platform comprising one or more processors, a network of sensors comprising at least one of the group of motion sensors, cameras, infrared sensors, noise detectors, or radio frequency (RF) receivers, and a countermeasure subsystem comprising at least one of the group of a sound-making device, a visual obscurant device, and a fire mitigation device, wherein the processing platform is in communication with the network of sensors and countermeasure subsystem.

In another exemplary embodiment of the present disclosure, a method of security is provided. The method involves utilizing a network of sensors to detect the presence of emergencies, receiving, by the processing platform, a signal from the network of sensors that an emergency has been detected at one or more emergency locations, deploying a countermeasure device in response to the signal received from the network of sensors that an emergency has been detected, and displaying, on a user device, a graphical representation of the emergency detected by the network of sensors.

In yet another exemplary embodiment of the present disclosure, a security system is disclosed comprising a processing platform configured to receive data from the network of sensors when the network of sensors detects the presence of an emergency, wherein the one or more processors are configured with connectivity modules for wired or wireless communications, a network of sensors comprising one or more of motion sensors, cameras, infrared sensors, noise detectors, radio frequency receivers, wherein the network of sensors is configured to detect the presence of an emergency and communicate the presence of an emergency to the one or more processors, an emergency activation device comprising one or more of key fobs and mobile devices, wherein the emergency activation device is configured to send data to the one or more processors indicating the presence of an emergency, a countermeasure subsystem comprising one or more of a sound making device configured to produce a flash of light above a predetermined candela value and a loud noise above a predetermined decibel value, a visual obscurant device comprising a spherical smoke releasing agent which releases smoke within a predetermined time, and a fire mitigation device, wherein the countermeasure device is deployable either by the user of the graphical user interface on the user device or automatically upon detection by the network of sensors of an emergency, and a graphical user interface displayable on a user device in communication with the centralized control unit.

In any of the embodiments disclosed herein, the processing platform can be configured to receive data from one or more sensors of the sensor network when the presence of an emergency is detected at one or more emergency locations.

In any of the embodiments disclosed herein, the processing platform can be further configured to deploy a countermeasure signal receivable by the countermeasure system.

In any of the embodiments disclosed herein, the security and/or deterrent system can be configured with an emergency activation subsystem comprising at least one of a group of key fobs and mobile devices, wherein the emergency activation subsystem is configured to send an emergency activation signal receivable by the processing platform, and wherein the emergency activation subsystem is operated manually by a user.

In any of the embodiments disclosed herein, the system can be configured with a graphical user interface displayable on a user device in communication with the processing platform.

In any of the embodiments disclosed herein, the graphical user interface displayable on a user device can be operated by a user, wherein the user device is capable of sending a signal to the processing platform. Furthermore, the processing platform, in response to the signal received from the user device, can be configured to send a countermeasure signal to the countermeasure subsystem.

In any of the embodiments disclosed herein, one or more processors of the processing platform can utilize an artificial intelligence system to detect the presence of an emergency and send a countermeasure signal to the countermeasure subsystem.

In any of the embodiments disclosed herein, the sound making device and visual obscurant can be mounted in a metal housing, wherein the fire mitigation device is positioned below the sound making device and visual obscurant.

In any of the embodiments disclosed herein, the sound making device can produce a flash of light above a predetermined candela value and a loud noise above a predetermined decibel value.

In any of the embodiments disclosed herein, the visual obscurant can be a spherical smoke releasing agent which releases smoke within a predetermined time.

In any of the embodiments disclosed herein, the entity that causes the presence of an emergency to be sensed can cause the countermeasure device to be automatically deployed.

In any of the embodiments disclosed herein, the countermeasure device can be a fire mitigation device.

In any of the embodiments disclosed herein, the countermeasure device can be deployed by the user of a user interface on a user device in communication with the one or more processors.

These and other aspects of the present disclosure are described in the Detailed Description below and the accompanying drawings. Other aspects and features of embodiments will become apparent to those of ordinary skill in the art upon reviewing the following description of specific, exemplary embodiments in concert with the drawings. While features of the present disclosure may be discussed relative to certain embodiments and figures, all embodiments of the present disclosure can include one or more of the features discussed herein. Further, while one or more embodiments may be discussed as having certain advantageous features, one or more of such features may also be used with the various embodiments discussed herein. In similar fashion, while exemplary embodiments may be discussed below as device, system, or method embodiments, it is to be understood that such exemplary embodiments can be implemented in various devices, systems, and methods of the present disclosure.

### BRIEF DESCRIPTION OF THE DRAWINGS

The following detailed description of specific embodiments of the disclosure will be better understood when read in conjunction with the appended drawings. For the purpose of illustrating the disclosure, specific embodiments are shown in the drawings. It should be understood, however, that the disclosure is not limited to the precise arrangements and instrumentalities of the embodiments shown in the drawings.

FIG. 1 provides a schematic depiction of a security or deterrent system, in accordance with an exemplary embodiment of the present invention.

FIG. 2 provides a schematic depiction of a security or deterrent system which is further configured with an emergency activation subsystem and a graphical user interface on a user device, in accordance with an exemplary embodiment of the present invention.

FIG. 3 provides a schematic depiction of the graphical user interface displayable on a user device which is communicative with the processing platform and countermeasure subsystem, in accordance with an exemplary embodiment of the present invention.

FIG. 4 provides a schematic depiction of the emergency activation subsystem which is communicative with the processing platform and countermeasure subsystem, in accordance with an exemplary embodiment of the present invention.

FIG. 5 provides a schematic depiction of the artificial intelligence subsystem which is communicative with the processing platform, in accordance with an exemplary embodiment of the present invention.

FIG. 6 provides a schematic representation of a method of security or deterrent, in accordance with an exemplary embodiment of the present invention.

FIGS. 7A-7B provide a graphical representation of the countermeasure subsystem, depicting both the exterior of the countermeasure subsystem (FIG. 7A) and the exterior of the countermeasure subsystem (FIG. 7B).

### DETAILED DESCRIPTION

To facilitate an understanding of the principles and features of the present disclosure, various illustrative embodiments are explained below. The components, steps, and materials described hereinafter as making up various elements of the embodiments disclosed herein are intended to be illustrative and not restrictive. Many suitable components, steps, and materials that would perform the same or similar functions as the components, steps, and materials described herein are intended to be embraced within the scope of the disclosure. Such other components, steps, and materials not described herein can include, but are not limited to, similar components or steps that are developed after development of the embodiments disclosed herein.

The systems and methods described herein provide, in accordance with different embodiments, examples in which a security or deterrent system can be utilized to detect and interdict emergencies. For example, embodiments as described herein may comprise a system designed to detect and interdict an emergency, such as an active shooter situation, a fire, or unauthorized entry. For example, in one embodiment, a network of sensors may be utilized to detect the presence of an emergency at an emergency location. For example, the network of sensors may consist of, without limitation, one or more of motion sensors, cameras, infrared sensors, noise detectors, or radio frequency receivers. Upon detection of the presence of an emergency, the network of sensors may send a signal to one or more processors which comprise a processing platform. In response to the signal received from the network of sensors that an emergency has been detected, the processing platform may send a countermeasure signal to a countermeasure subsystem. In response to the countermeasure signal received by the countermeasure subsystem from the processing platform, the countermeasure subsystem may cause a countermeasure device to be released. For example, the countermeasure device may be a visual obscurant device, or a fire mitigation device, or a sound-making device.

Other aspects of the present disclosure may include a method of providing a security or deterrent system. For example, a network of sensors may be utilized to detect the presence of an emergency at one or more emergency location. The network of sensors may then send an emergency activation signal to a processing platform comprising one or more processors. Alternatively, or in addition, an emergency activation device may be used by a user to send an emergency activation signal receivable by the processing platform. The processing platform, upon receipt of the emergency activation signal, either from the network of sensors or the emergency activation device, may then display, on a user device, a graphical user interface providing a graphical representation of the emergency. The user of a user device may, from the graphical user interface, send an emergency activation signal to the processing platform. The signal may be intended to trigger the processing platform to send a countermeasure signal to the countermeasure subsystem. The processing platform may send a countermeasure signal based at least in part on information received from the network of sensors, the emergency activation device, or the user device. The countermeasure subsystem may be comprised of one or more countermeasure devices and is configured to receive, from the processing platform, a countermeasure signal that causes one or more countermeasure devices to be deployed with the intention of attempting to interdict the emergency.

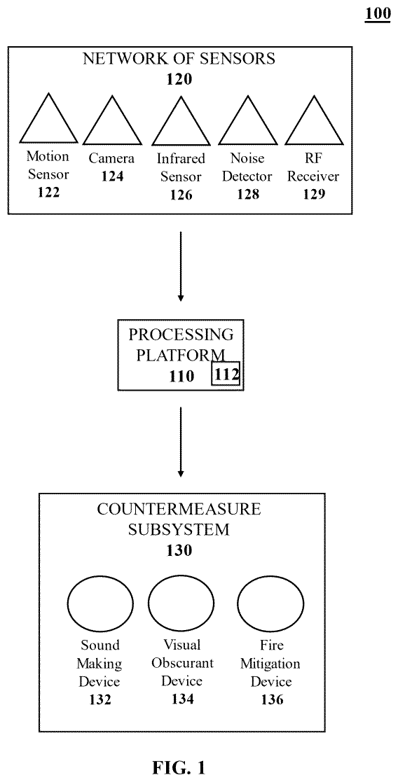

Referring now to the drawings, FIG. 1 depicts a security or deterrent system 100 in accordance with one embodiment of the present disclosure. The components and arrangements shown in FIG. 1 are not intended to limit the disclosed invention as the components used to implement the disclosed process and features may vary.

The system first comprises a network of sensors 120. The network of sensors 120 may include, but are not limited to, a motion sensor 122, a camera 124, an infrared sensor 126, a noise detector 128, and/or a radio frequency (RF) receiver 128. The network of sensors 120 is designed to monitor a predetermined location continuously, or at predetermined time intervals, for the presence of an emergency at one or more emergency locations. The one or more sensors comprising the network may be generally implemented in hardware. In addition, the one or more sensors comprising the network may be placed in a location within the premises to be secured that depends on the particular function of the sensor. For example, and without limitation, a camera may be placed at a location within the premises that allows for the most advantageous field of vision. In addition, or alternatively, a motion sensor may be placed at an entrance or doorway so as to detect unauthorized entry. In addition, or alternatively, a noise sensor may be placed beside a window of the premise to be secured in order to detect the sound of glass breaking in the event of an unauthorized entry of the secured premises. Upon the detection by the network of sensors 120 of an emergency at one or more locations, the network of sensors may be configured to send an emergency activation signal receivable by the processing platform 110.

Turning specifically to the motion sensor 122, the motion sensors are manufactured in shapes that suit their specific functions. For example, the motion sensor 122 can be, without limitation, a wall-mounted motion sensor, including without limitation a passive infrared (PIR) detectors and glass-break sensors. These sensors are typically rectangular or box-shaped. Beam sensors, which may use infrared or microwave technology, are often housed in barrel or tubular casings. Flat panel sensors are used in floor pressure mats or on surfaces requiring intrusion detection. Panic buttons and acoustic sensors are usually round or button-shaped for ease of activation and compact installation. In any instance, the motion sensors 122 may generally be utilized to detect motion within the secured premises, which may indicate the presence of an emergency situation at one or more emergency locations. For example, and without limitation, if the motion sensor 122 detects motion at a time of day at which persons are not permitted to enter the secured premises, this may signal the existence of an unauthorized entry. In this case, the motion sensor 122 may send an emergency activation signal to the processing platform 110 that an unauthorized entry has occurred at the secured premises.

The motion sensor 122 will generally measure from 3 to 12 inches (75 to 150 millimeters), or from 3 to 4 inches, 3 to 5 inches, 3 to 6 inches, 3 to 7 inches, 3 to 8 inches, 3 to 9 inches, 3 to 10 inches, or 3 to 11 inches in height or width, depending on the design and mounting method.

Turning specifically to the camera 124, the camera may be, without limitation, a 360-degree panoramic camera setup using dome or turret-style pan-tilt-zoom (PTZ) technology. These cameras provide optical zoom capabilities of up to 40× magnitude, allowing operators to read license plates or identify faces from a distance. The cameras may also feature night vision support through infrared LEDs and/or thermal imaging, along with motion tracking that allows automatic subject locking and following. Recorded footage may be stored on an onboard solid-state drive (SSD) or network video recorder (NVR) and can be retained for periods of 30 to 90 days. A cloud backup option may be implemented to ensure redundancy and remote accessibility.

Turning specifically to the infrared sensor 126, the sensors may include, without limitation, passive infrared (PIR) detectors and beam sensors, which may use infrared or microwave technology, and which are house in barrel-shaped or tubular casings.

Turning specifically to the noise detector 128, the noise detector may be configured to detect any sound above a predetermine decibel value, for example above 20 decibels, or above 30 decibels, or above 40 decibels, or above 50 decibels, or above 60 decibels, or above 70 decibels, or above 80 decibels, or above 90 decibels, or above 100 decibels, or above 110 decibels, or above 120 decibels. For example, a noise detector may be configured to detect a sound with a decibel level consistent with the existence of an emergency situation, including without limitation a gunshot or the sound of glass breaking.

The processing platform 110 is comprised of one or more processors, which are communicative with the network of sensors 120 and the countermeasure subsystem 130. For example, upon detection by the network of sensors that an emergency situation is present at one or more emergency locations, the network of sensors may send an emergency signal receivable by the one or more processors of the processing platform 110. In response, the processing platform may send a countermeasure signal to the countermeasure subsystem 130 to release an appropriate countermeasure device. The processing platform may comprise, without limitation, a mobile device, mobile computing device, a mobile station (MS), terminal, cellular phone, cellular handset, personal digital assistant (PDA), smartphone, wireless phone, organizer, handheld computer, desktop computer, laptop computer, tablet computer, set-top box, television, appliance, game device, medical device, display device, or some other like terminology. The processing platform 110 may be a processor, controller, or a central processing unit (CPU), or a set of hardware components.

The processing platform may also contain a memory 112. The memory 112 may include, in some embodiments, one or more of a microprocessor, microcontroller, digital signal processor, co-processor, or the like, or combinations thereof capable of executing stored instructions and operating upon stored data. The memory 112 may include, in some embodiments, one or more suitable types of memory, including without limitation volatile or non-volatile memory, random access memory (RAM), read only memory (ROM), programmable read-only memory (PROM), erasable programmable read-only memory (EPROM), electrically erasable programmable read-only memory (EEPROM), magnetic disks, optical disks, floppy disks, hard disks, removable cartridges, flash memory, a redundant array of independent disks (RAID), for storing files including an operating system, application programs (including, for example, a web browser application, a widget or gadget engine, and or other applications, as necessary), executable instructions and data. The memory 112 may further include one or more memory devices that store data and instructions used to perform one or more features of the disclosed embodiments. The memory 112 may include software components that, when executed by the processing platform 110, perform one or more processes consistent with the disclosed embodiments.

The countermeasure subsystem 130 upon receiving a countermeasure signal from the processing platform 110 may be configured to release an appropriate countermeasure device to intervene in the presence of an emergency at one or more emergency locations. For example, if a fire were to be detected by one or more sensors of the network of sensors 120, an emergency activation signal may be sent to the processing platform 110. In turn, the processing platform may send a countermeasure signal to the countermeasure subsystem 130 to release an appropriate countermeasure device, for example a fire mitigation device.

The countermeasure subsystem may be further comprised of one or more countermeasure devices. The one or more countermeasure devices are intended to be released in response to a countermeasure signal received by the countermeasure subsystem 130 from the processing platform 110. The countermeasure subsystem 130 may include one or more countermeasure devices designed to respond to a particular type of emergency situation, including without limitation a fire, unauthorized entry, or active shooter situation. Each of three exemplary countermeasure devices of the countermeasure subsystem will be discussed in turn.

The countermeasure subsystem may comprise one or more sound making devices 132. The sound making device may be designed to, upon release, make a loud sound and/or bright flash of light that would temporarily disorient the causer of an emergency situation without causing lethal injury to the causer of an emergency situation. In the time that the causer of the emergency is disoriented, security personnel may be able to intervene and neutralize the emergency situation. The sound making device may include, without limitation, a flashbang or concussion grenade, or any other device capable of making a loud noise and/or a bright flash of light.

The sound making device may be configured to produce a loud sound above a predetermined decibel value, for example above 90 decibels, or above 100 decibels, or above 110 decibels, or above 120 decibels, or above 130 decibels, or above 140 decibels, or above 150 decibels, or above 160 decibels, or above 170 decibels, or above 180 decibels.

The sound making device may be further configured to produce an intense flash of light above a predetermined candela value, for example up to 1 million candela, or above 1 million candela, or above 2 million candela, or above 3 million candela, or above 4 million candela, or above 5 million candela, or above 6 million candela, or above 7 million candela.

Alternatively, or in addition, the countermeasure subsystem may comprise one or more visual obscurant devices 134. For example, the visual obscurant device may be a smoke or fog-releasing device designed to disorient the causer of an emergency. The visual obscurant device may be configured to release smoke or fog within a predetermined time of receipt of a countermeasure signal, for example under one minute, or under 45 seconds, or under 30 seconds, or under 15 seconds, or under 10 seconds, or under 5 seconds, or under 3 seconds, or under 2 seconds, or under 1 second.

The visual obscurant device 134 may further be configured to release smoke or fog for a predetermined amount of time, for example 10 seconds or more, or 15 seconds or more, or 30 seconds or more, or 45 seconds or more, or 1 minute or more, or 2 minutes or more, or 5 minutes or more, or 10 minutes or more, or 15 minutes or more, or 30 minutes or more.

Alternatively, or in addition, the visual obscurant device 134 may include a device configured to release an irritant designed to disorient the causer of an emergency situation without causing lethal injury. For example, the visual obscurant device may include a chemical irritant, including without limitation peppery spray or tear gas. These devices are capable of incapacitating the causer of an emergency situation by causing intense respiratory irritation, eye watering, and skin burning sensations, while also causing minimal long-term harm to the causer of an emergency situation.

Alternatively, or in addition, the countermeasure subsystem may comprise a fire mitigation device 136. For example, the fire mitigation device may include, without limitation, a fire extinguisher ball that has a binary explosive inside of the fireball, fire extinguisher tanks, devices that can be filled with water, or any fire suppressant designed to intervene in the event of a fire. Furthermore, the fire mitigation device 136 may include system aerosol fire suppression systems operated by releasing a fine mixture of solid particles and gas, which interferes with the fire chemically and physically. Compact and self-contained, these systems are ideal for enclosed and sensitive environments such as electrical cabinets, server rooms, and vehicle engine compartments.

Referring specifically to the countermeasure subsystem 130, the countermeasure devices may be mounted in a fixed housing, for example a wooden housing or a metal housing. The one or more countermeasure devices may be mounted on the exterior of the housing, in order that they may be more easily released upon receipt of a countermeasure signal. Alternatively, or in addition, one or more countermeasure devices may be mounted on the interior of the housing, in order that the countermeasure devices are protected from interference. In any instance where a fire mitigation device 136 is utilized, the fire mitigation device may be positioned below the sound making device and/or visual obscurant, to allow the contents of the fire mitigation device to be released without hinderance.

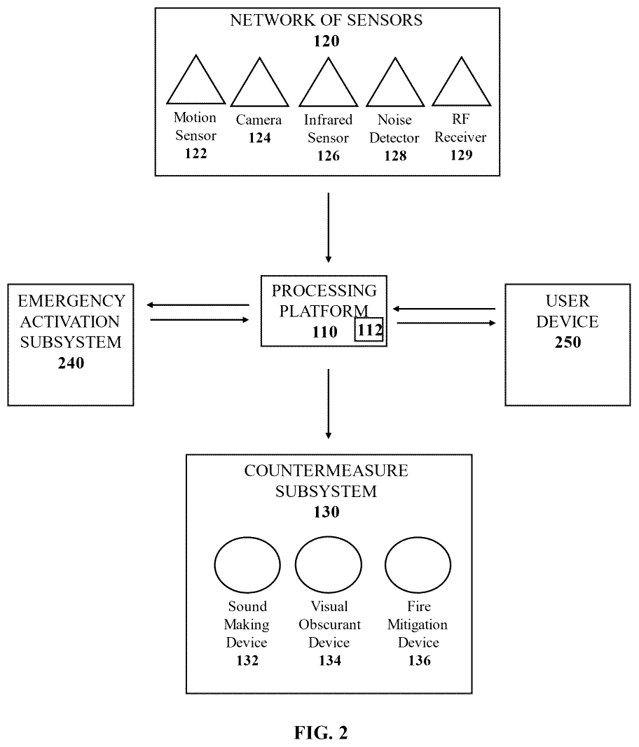

An exemplary embodiment of the security or deterrent system is shown in FIG. 2. The processing platform 110, network of sensors 120 and countermeasure subsystem 130 may have a structure and components that are similar to those described with respect to FIG. 1. As shown, the processing platform 110 may be configured to receive an emergency activation signal from the network of sensors 120 and send a countermeasure signal to the countermeasure subsystem 130. In addition, the processing platform 110 may be communicative with an emergency activation subsystem 240 and/or a user device 250. For example, the processing platform 110 may be configured to receive an emergency activation signal from the emergency activation subsystem 240, and thereafter send a countermeasure signal to the countermeasure subsystem 130. Alternatively, or in addition, the processing platform 110 may be configured, upon receipt of an emergency activation signal from either the network of sensors 120 or the emergency activation subsystem 240 to display, on the user device 250, a graphical user interface which conveys to the user of the user device 250 pertinent information regarding the emergency situation at one or more emergency locations. The user of the user device, based at least in part on information received from the processing platform 110, may choose to select an appropriate countermeasure device to deployed, at which point the processing platform 110 will send a countermeasure signal to the countermeasure subsystem to release the appropriate countermeasure device. For example, and without limitation, if the noise detector 128 of the network of sensors 120 detects a sound with a decibel level consistent with a gunshot, an emergency activation signal may be sent to the processing platform 110. In turn, the processing platform 110 may send a notification to the user of a user device that a potential active shooter situation is underway and display a live camera feed from the camera 122 of the network of sensors 120 on the graphical user interface displayable on the user device 250. The user of the user device 250 may then select an option on the graphical user interface to deploy a visual obscurant device 134, at which point a signal will be sent to the processing platform 110. Then, the processing platform 210 will send the appropriate countermeasure signal to the countermeasure subsystem 130 to release the visual obscurant device 134.

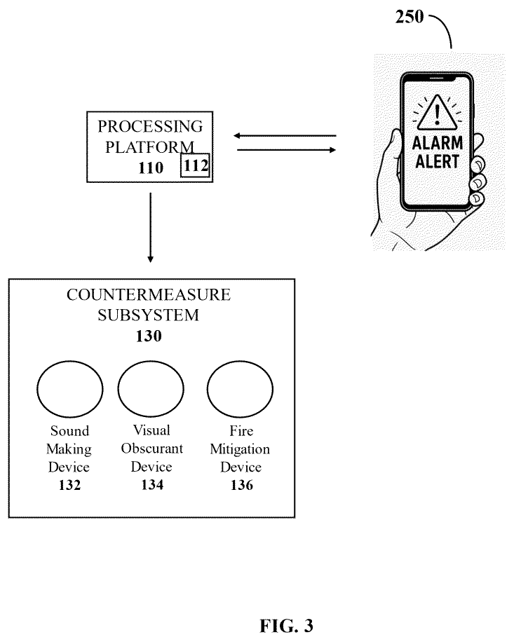

With reference to FIG. 3, and in accordance with a preferred embodiment of the present disclosure, a schematic representation of the communication of the mobile device 250 with the processing platform 110 and countermeasure subsystem 130 is shown in further detail. The processing platform 110 and countermeasure subsystem 130 may have a structure and components similar to those described with respect to FIG. 1.

The mobile device 250 may include, without limitation, a mobile computing device, a mobile station (MS), terminal, cellular phone, cellular handset, personal digital assistant (PDA), smartphone, wireless phone, organizer, handheld computer, desktop computer, laptop computer, tablet computer, set-top box, television, appliance, game device, medical device, display device, or some other like terminology. The mobile device 310 may be further configurable with other devices of general implementation, such as a computer mouse, monitors, headphones, touch screen capability, or other like technology.

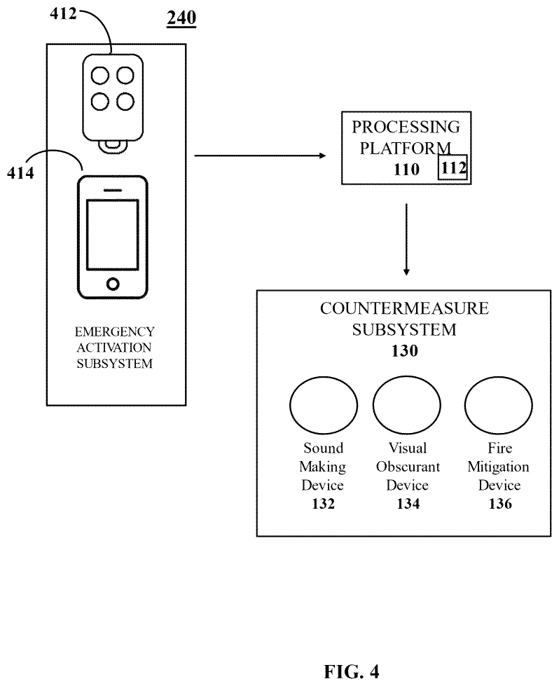

With reference to FIG. 4, and in accordance with a preferred embodiment of the present disclosure, a schematic representation of the communication of the emergency activation subsystem is shown in further detail. The processing platform 110 and countermeasure subsystem 130 may have a structure and components similar to those described with respect to FIG. 1. The emergency activation subsystem 240 may have a structure and components similar to those described with respect to FIG. 1. The emergency activation subsystem 240 may include, without limitation, a key fob 412 and/or a mobile device 414. The key fob and/or mobile device may be used in addition to or in conjunction with the network of sensors as a way to send an emergency activation signal to the processing platform 110 that an emergency situation is occurring/has occurred at one or more emergency locations. For example, and without intending to be limited to one particular embodiment, a user may carry a key fob 412 on their person when located on the premises protected by the security or deterrent system. If the user detects that an emergency, including without limitation a fire, active shooter, or unauthorized entry, has occurred, the user may use the key fob 412 to press a button to send an emergency activation signal to the processing platform 110 indicating that an emergency is occurring at one or more emergency locations. The processing platform 110 may then display information regarding the emergency to the user device 250 and/or send an appropriate countermeasure signal to the countermeasure subsystem 130, in accordance with other exemplary embodiments of the present disclosure.

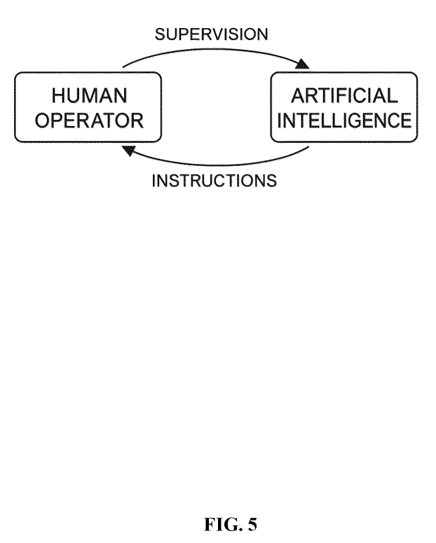

With reference to FIG. 5, and in accordance with an exemplary embodiment of the present disclosure, a graphical representation of artificial intelligence is disclosed. Using certain artificial intelligence models, including without limitation large-language models (LLMs), the processing platform 110 may be configured to predict or suggest an appropriate countermeasure device to be deployed. Additionally, or alternatively, the processing platform 110 may be configured to use artificial intelligence in order to automatically deploy an appropriate countermeasure device more rapidly than a human operator could.

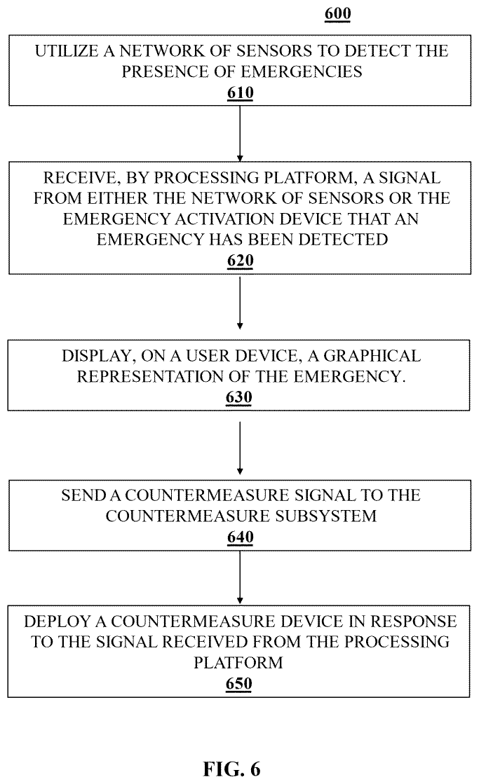

With reference to FIG. 6, and in accordance with an exemplary embodiment of the present disclosure, a method for providing security is shown. Method 600 may be performed by a processor 604 which is communicative with the network of sensors 602, the user device 606, and the countermeasure system 606. In some embodiments, steps of method 600 may be delegated to other elements in system 100 or 200, such as the emergency activation device 250. Following method 600, users may provide security to a predetermined secured premises.

In block 610, the network of sensors 120 may monitor the location where security is to be provided for the presence of an emergency at one or more emergency locations. In block 620, the processing platform may receive a signal either from the one or more sensors of the network of sensors 120 or the emergency activation device 240 that an emergency has been detected at one or more emergency locations. In block 630, the processing platform 620 may cause a graphical representation of the emergency to be displayed on a user device 250. After displaying to the user device 250 a graphical representation of the emergency, the user device 250 may receive input from a user. For example, the user may opt to send a signal to the processing platform 110 to send a countermeasure subsystem 130 to deploy an appropriate countermeasure device depending on the type of emergency.

In block 640, a countermeasure signal may be sent to the countermeasure subsystem in order to deploy an appropriate countermeasure device. The countermeasure signal may be sent by the processing platform 110, based at least in part on a signal received from the network of sensors 120, the emergency activation device 240, or the user device 250. Upon receipt by the processing platform 110 of an emergency activation signal, a signal may be sent to the countermeasure subsystem to deploy a countermeasure device appropriate for the particular type of emergency detected. For example, and without intending to be limited to one particular embodiment, the user of an emergency activation device may press a button indicating that an active shooter situation is ongoing. In response, the processing platform 110 may then send a countermeasure signal to the countermeasure subsystem 130 to release a visual obscurant device 134 to deter the threat.

In block 650, in response to a countermeasure signal, the countermeasure subsystem may cause an appropriate countermeasure device to be deployed. For example, and without intending to be limited to one particular embodiment, the countermeasure subsystem may cause a sound making device 132 to be released, or a visual obscurant device 134, or a fire mitigation device 136. The countermeasure subsystem may also cause multiple countermeasure devices to be released.

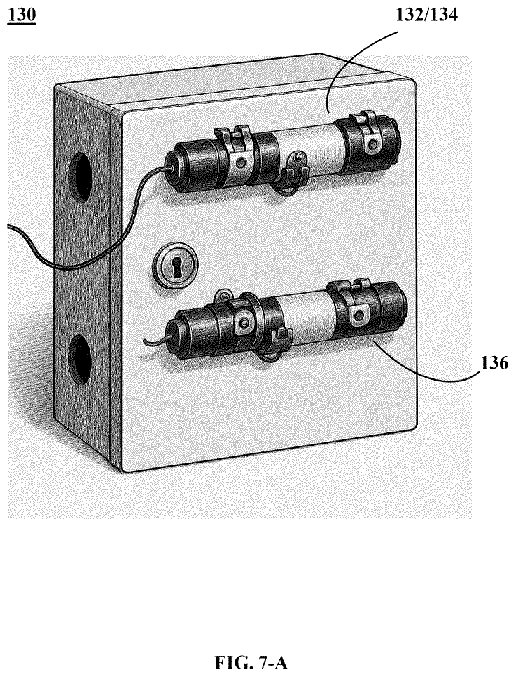

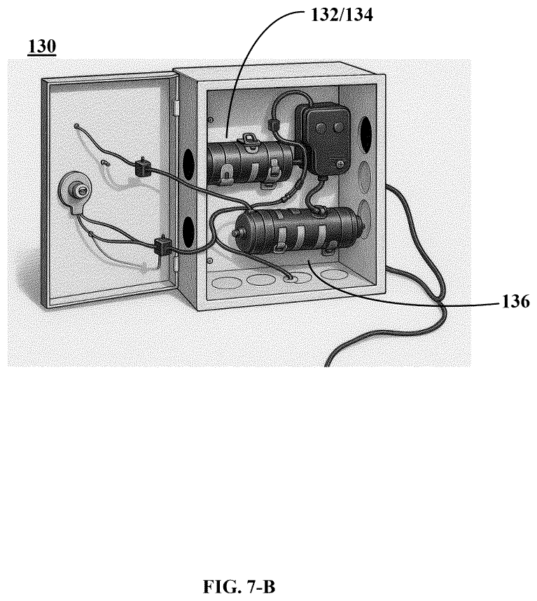

FIGS. 7A-7B depict an example of a housing for the countermeasure devices of the countermeasure subsystem 130, in accordance with an exemplary embodiment of the present disclosure. FIG. 7A depicts a housing for the countermeasure subsystem 130 wherein the countermeasure devices are housed on the exterior of the countermeasure subsystem 130. In an exemplary embodiment, the countermeasure devices may be house on the exterior of the countermeasure subsystem 130 in order to facilitate ease of release of the countermeasure device(s). FIG. 7B depicts a housing for the countermeasure subsystem 130 wherein the countermeasure devices are house in the interior of the subsystem in order to house the countermeasure devices securely in the housing so that they may not be accessed. In either of FIGS. 7A-7B, the fire mitigation device 136 is positioned below either the sound making device and/or visual obscurant so that the fire mitigation device may be deployed and its contents dispersed without the hindrance of other countermeasure devices positioned near the fire mitigation device.

It is to be understood that the embodiments and claims disclosed herein are not limited in their application to the details of construction and arrangement of the components set forth in the description and illustrated in the drawings. Rather, the description and the drawings provide examples of the embodiments envisioned. The embodiments and claims disclosed herein are further capable of other embodiments and of being practiced and carried out in various ways. Also, it is to be understood that the phraseology and terminology employed herein are for the purposes of description and should not be regarded as limiting the claims.

Accordingly, those skilled in the art will appreciate that the conception upon which the application and claims are based may be readily utilized as a basis for the design of other structures, methods, and systems for carrying out the several purposes of the embodiments and claims presented in this application. It is important, therefore, that the claims be regarded as including such equivalent constructions.

Furthermore, the purpose of the foregoing Abstract is to enable the United States Patent and Trademark Office and the public generally, and especially including the practitioners in the art who are not familiar with patent and legal terms or phraseology, to determine quickly from a cursory inspection the nature and essence of the technical disclosure of the application. The Abstract is neither intended to define the claims of the application, nor is it intended to be limiting to the scope of the claims in any way.

What is claimed is:

1. A security/deterrent system comprising:
a processing platform comprising one or more processors;
a detection network comprising sensors, the detection network communicative with the processing platform; and
a countermeasure subsystem comprising countermeasure devices, the countermeasure subsystem communicative with the processing platform;
wherein:
the processing platform is configured to:
receive sensor data from a sensor of the detection network indicative of an emergency detected by the sensor; and
deploy a countermeasure signal receivable by a countermeasure device of the countermeasure subsystem.

2. The security/deterrent system of claim 1, wherein:
at least a portion of the sensors of the detection network are each selected from a group consisting of motion sensors, cameras, infrared sensors, noise detectors, radio frequency receivers, and a combination thereof; and
at least a portion of the countermeasure devices of the countermeasure subsystem are each selected from a group consisting of a sound making device, a visual obscurant device, a fire mitigation device, and a combination thereof.

3. The security/deterrent system of claim 1 further comprising an emergency activation subsystem communicative with the processing platform and operable manually by a user;
wherein the processing platform is further configured to:
receive emergency activation data from the emergency activation subsystem indicative of an emergency detected by the user; and
deploy a user-initiated countermeasure signal receivable by a countermeasure device of the countermeasure subsystem.

4. The security/deterrent system of claim 3, wherein:
the emergency activation subsystem comprises one or more user devices; and
at least a portion of the user devices of the emergency activation subsystem are each selected from a group consisting of a key fob and a mobile device.

5. The security/deterrent system of claim 4, wherein the system is configured to generate a display on the user device.

6. The security/deterrent system of claim 1, wherein the processing platform utilizes an artificial intelligence system to at least one of:
predict an emergency at an emergency location;
detect the presence of an emergency; or
send a countermeasure signal to the countermeasure subsystem.

7. A security/deterrent system comprising:
a processing platform comprising one or more processors;
a detection network comprising sensors, the detection network communicative with the processing platform;
an emergency activation subsystem communicative with the processing platform and operable manually by a user; and
a countermeasure subsystem comprising countermeasure devices, the countermeasure subsystem communicative with the processing platform;
wherein:
the processing platform is configured to:
receive sensor data from a sensor of the detection network indicative of an emergency detected by the sensor at a sensor emergency location;
receive emergency activation data from the emergency activation subsystem indicative of a emergency detected by the user at a user emergency location;
deploy a countermeasure signal receivable by a countermeasure device of the countermeasure subsystem located in proximity of the sensor emergency location; and
deploy a user-initiated countermeasure signal receivable by a countermeasure device of the countermeasure subsystem located in proximity of the user emergency location;
at least a portion of the sensors of the detection network are each selected from a group consisting of motion sensors, cameras, infrared sensors, noise detectors, radio frequency receivers, and a combination thereof; and
at least a portion of the countermeasure devices of the countermeasure subsystem are each selected from a group consisting of a sound making device, a visual obscurant device, a fire mitigation device, and a combination thereof; and
the emergency activation subsystem comprises one or more user devices.

8. The security/deterrent system of claim 7, wherein:
a first fire mitigation device of the countermeasure devices is located in proximity to at least one of a first sound making device of the countermeasure devices or a first visual obscurant device of the countermeasure devices; and
the fire mitigation device is positioned below the sound making device and/or visual obscurant device.

9. The security/deterrent system of claim 7, wherein:
a sound making device of the countermeasure devices is configured to produce:
a noise above a predetermined decibel value; and
a flash of light above a predetermined candela value.

10. The security/deterrent system of claim 7, wherein:
a visual obscurant device of the countermeasure devices is a spherical smoke releasing device which releases smoke within a predetermined time.

11. The security/deterrent system of claim 7 further comprising an artificial intelligence system;
wherein:
the processing platform utilizes the artificial intelligence system to at least one of:
automatically adjust a sensitivity of the sensors of the detection network to detect the emergency;
automatically adjust a severance of the response of the countermeasure devices;
fully automate the detection of and response to the emergency; or determine a lethality of the emergency.

12. A security system comprising:
a processing platform configured to receive data indicative of a presence of an emergency, wherein the one or more processors are configured with connectivity modules for wired or wireless communications;
a network of sensors comprising one or more of motion sensors, cameras, infrared sensors, noise detectors, and radio frequency receivers, wherein the network of sensors is configured to detect the presence of the emergency and communicate the presence to the processing platform;
an emergency activation subsystem comprising one or more of key fobs and mobile devices of a user, wherein the emergency activation subsystem is configured to send the user's detection of the emergency and communicate the presence to the processing platform;
a graphical user interface displayable on the mobile device of the user; and
a countermeasure subsystem comprising one or more of:
a sound making device configured to produce a flash of light above a predetermined candela value and a loud noise above a predetermined decibel value;
a visual obscurant device comprising a spherical smoke releasing agent which releases smoke within a predetermined time; and
a fire mitigation device;
wherein the countermeasure device is deployable either by the user of the graphical user interface on the user device or automatically upon detection by the network of sensors of an emergency.

13. The security system of claim 12, wherein the processing platform is further configured to:
receive data from the network of sensors when the network of sensors detects the presence of the emergency; and
deploy a countermeasure from the countermeasure subsystem based, at least on part on, the data received from the network of sensors.

14. The security system of claim 13 further comprising:
a centralized control system utilizing an artificial intelligence system to detect the presence of the emergency and deploy the countermeasure device.
